(19) United States
(12) Patent Application Publication
(10) Pub. No.: US 2022/0080705 A1
(43) Pub. Date: Mar. 17, 2022

(54) COST EFFECTIVE ANTIVIRAL PLASTIC FILM, ITS METHOD OF MAKING AND APPLICATIONS

(71) Applicant: Laurence C. CHAN, San Diego, CA (US)

(72) Inventor: Laurence C. CHAN, San Diego, CA (US)

(21) Appl. No.: 17/022,913

(22) Filed: Sep. 16, 2020

(51) Int. Cl. B32B 15/20; B32B 15/085; B32B 15/082; C08J 5/18; B29C 48/08

(52) U.S. Cl. CPC B32B 15/20; B32B 15/085; B82Y 30/00; C08J 5/18; B29C 48/08; B32B 15/082

(57) ABSTRACT

This invention involves a cost effective antiviral plastic film with variable physical properties, comprising of at least one thinner surface layer to minimize the amount of the expensive copper nano-powders required to render the film to be antiviral, and one thicker substrate layer with variable physical properties and thickness. The plastic film is made using a co-extrusion cast film or a blown film process so that the antiviral surface layer and the substrate are joined together as they are made into a multilayer film. The physical properties for the plastic film can be varied by using different kinds of polymeric materials such as PE, PP, PVC, Nylons and others. Its low cost combined with variable physical properties make our invented film suitable for making a wide variety of affordable and safer protection products against the COVID-19. Such products include gloves, masks, covers, wrappers, curtains, bags and protective apparels, for use by individuals, healthcare facilities, restaurants and other industries.

### SCOPE OF INVENTION

This invention involves an antiviral plastic film and its applications in the field of personal protection equipment and other protection products for use by individuals, healthcare facilities, food processing plants, restaurants, and other industries.

### BACKGROUND

Since the beginning of 2020, COVID-19 has become a pandemic disease spreading around to the whole world. The coronavirus has infected many millions of people which have resulted very high number of deaths in many countries. In order to avoid infection by the coronavirus, many types of personal protection equipment (PPE) and other protection products have been used extensively in most public and private places, including healthcare facilities, offices, restaurants, factories, supermarkets, buses, airplanes, etc. The products include: face masks, face shields, surgical caps, shoes covers, medical gloves, surgical gowns, etc.

Currently, most PPE are made of plastic materials and nonwoven fabric which protect the users by forming a barrier against the entries of the coronavirus into their bodies. The conventional PPE materials do not have any active agents that can destroy the coronavirus. When a PPE wearer has been in contact with another infected person, the coronavirus particles or droplets from the infected person could not enter the wearer's body, but they can settle on the PPE surface for a long period of time. A recent study showed that the COVID-19 coronavirus can stay active on most surfaces for up to 4 days, with the exception of copper surface which could inactive the coronavirus in 4 hours. Therefore, the wearer of the regular PPE products could unknowingly be infected when their hands had touched their own infected PPE or other surface and then later also touched their own nose, eye or mouth.

In addition to the surface on the PPE wearers, some surfaces that are also well-known to have high probability of causing infections due to their frequent touches by people are: Elevator buttons and door knobs, table tops and chairs in restaurants and bars, seats in taxis and airplanes, hand rails in malls and buses, counters and curtains in hospitals, fruits and vegetables in supermarkets. Knowing the above high possibility of getting infection, it is now generally recommended that these surfaces to be sprayed and wiped with alcohol or other disinfectants in intervals of two to 4 hours. The wiping would definitely improved the safety of these surfaces, but it is not reliable because the surfaces could be contaminated by infected people in between the wipes.

In order to improve the safety protection performance of the PPE against the coronavirus, a few companies have attempted to make the PPE products with materials that include an antiviral agent which could destroy the coronavirus. In the 2^{nd} quarter of 2020, some companies in the US, Australia, Japan and South Korea have started making and promoting such products, including face mask, respirators and plastic films that have copper particles. However, the use of the antiviral PPE products is still very limited. They major obstacle is due to the much higher cost for the copper agent comparing to the raw materials for making the PPE products. For example, the price of a face mask made of copper coated fibers is about 20 times that for a regular face mask.

### SUMMARY OF INVENTION

Our invention involves a cost effective antivirus plastic film comprising at least one thinner antiviral surface layer and one thicker substrate layer; wherein the surface layer is controllable to be as thin as 8 μm to minimize the amount of the expensive copper based nano-powder required to render the film to be antiviral; wherein the substrate layer can be made of many kinds of polymeric materials with thickness ranging from 20 to 500 μm to provide different physical properties for the plastic film.

The plastic film is made using a co-extrusion cast film or a blown film process so that the antiviral surface layer and the substrate are joined together as they are made into a multilayer film. From our research, we found the following materials are suitable: Low Density Polyethylene (LDPE), High Density Polyethylene (HDPE), Chlorinated Polyethylene (CPE), Ethylene Vinyl Acetate (EVA), Polypropylene (PP), Polyvinylchloride (PVC), Polyethylene terephthalate (PET) and Nylon. However, the physical properties for the plastic films made with the above materials are different due to their different molecular structures and basic properties.

The combination of low cost and variable physical properties will enable our invented antiviral plastic film to be used for making a wide variety of affordable and safer protection products, such as: (a) Bags and wrappers for storage and waste, (b) Covers for hospital beds, trolleys, chairs, counters, furniture and elevator buttons, (c) Curtains and tents for patient isolation and hospital entrances, (f) Surgery accessories such as gowns, drapes, head caps and shoe covers, (g) Covers for tables and seats in restaurants, buses and airplanes. (a) Gloves for medical use and food handling, (b) Masks and respirators for personal protection,

### DETAILED DESCRIPTION OF INVENTION

In light of the aforementioned shortage of antiviral protection products, the goal of the present invention is the provision of a most cost effective antiviral medium that will enable a wide variety of safer and more affordable protection products to be available for use by individuals, healthcare, residential and commercial facilities. In the present invention, our focus is on the using of plastic films as the medium because plastic films are used extensively in making many protection products, such as: mask, respirators, gloves, covers, bags, many accessories and apparel for surgery and self-protection. Preferably, the cost for the antiviral plastic films should be as low as possible and whose physical properties can be varied in accordance to the requirements of the safety products which are made of the plastic films. In addition, the making of the antiviral plastic films should be as automated as much as possible so that their manufacturing cost can be well-controlled.

For the plastic film making process, the most commonly used processes are the cast film and the blown film technology. In general, cast film technology has higher production speed and most multilayer plastic films are made by this process nowadays. In contrast, blown film technology is generally used for making thinner films and also films with more specialized properties. Both the blown film and cast film technology can make plastic film with a single layer or multilayer structure for more than 10 layers. The plastic materials that can be made by blown film and cast film technology include: Low Density Polyethylene (LDPE), High Density Polyethylene (HDPE), Chlorinated Polyethylene (CPE), Ethylene Vinyl Acetate (EVA), Polypropylene (PP), Polyvinylchloride (PVC), Polyethylene terephthalate (PET) and Nylon. Below is a table with the typical properties for these polymers.

TYPICAL PROPERTIES OF POLYMERIC MATERIALS

| | | | | | Highest |
|---|---|---|---|---|---|
| | | | | | Continuous |
| | | Specific | Tensile | Elongation | Use |
| Material | | Gravity | Strength | to Break | Temperature |
| | Units | | Psi | % | ⁿC. |
| | ASTM Test | D792 | D638 | D638 | |
| | Standard | | | | |
| LDPE | | 0.92 | 1,400 | 500 | 80 |
| HDPE | | 0.96 | 4,000 | 600 | 80 |
| EVA | | 0.92 | 3,580 | 770 | 80 |
| CPE | | 0.95 | 3,000 | 1,300 | 120 |
| PP | | 0.91 | 5,400 | 100 | 120 |
| PVC | | 1.42 | 5,000 | 600 | 80 |
| PET | | 1.38 | 11,500 | 70 | 150 |
| Nylon | | 1.14 | 12,400 | 300 | 170 |

As shown in the above table, the properties for the plastic films made with the above polymers have different properties. In general, PE is known for its flexibility and it is the most commonly used plastic film because of its versatility. Further, PE has two versions with different levels of strengths and flexibility: low density (LDPE) and high density (HDPE). CPE is slightly cheaper and stiffer than PE. EVA is more elastic than PE but more expensive. PP is stronger but it is not as flexible as PE. PVC is cheaper than PE but not as environmentally friendly compared to PE. PET is stronger and more expensive than PE. Nylon is much tougher and stronger than PE but is also much pricier than PE. As for the film thickness, it was found that the thickness for the substrate layer of the plastic film made using the cast film or the blow film process can range from 20 to 500 μm and that the surface layer thickness can be low as 8 μm.

In order to control the manufacturing cost of the antiviral film, a major consideration is the high price of the antiviral agent which could be many times more than the price of the plastic film material. For a conventional mono-layer plastic film, the antiviral agent would need to be included throughout of the whole film. Because of the high price of the antiviral agent relative to the plastic raw material, even a small amount of the agent would increase the cost for the finished product substantially. As an illustration of the high cost impact by the antiviral agent: Assuming that it is required to include 10% of the agent in the plastic film and its cost is 30 times that of the plastic film. If the price for the regular film is $1, the addition of 0.1% of the copper will increase its cost by $3 (=0.1×$30). Therefore, the raw material cost increase for the antiviral film is 300%.

In order to lower the raw material cost for the antiviral plastic film, we have developed a technology that uses lesser amount of the expensive antiviral agent. From our extensive research, we found out that the best technology to use is a plastic film with at least two layers; wherein the antiviral agent is restricted to the surface layer only. If desired, we can also made the plastic film to have only one surface layer or two surface layers that contain the antiviral agent. The surface layer of a plastic film can be made to be as thin as 8 μm. Note that for such low thickness, the film is too fragile to be a stand-alone film and needs to be supported by a substrate layer. As an illustration of the cost savings using a 2-layer film: The thickness of the surface layer is 10% of the total thickness of the plastic film. The cost of the antiviral agent is 30 times that for the plastic film which cost $1 per piece, and 10% of the antiviral agent is required. For the 2 layer antiviral film, the cost increase is only $0.3 (=0.1×$1×$3×0.1). In contrast, the cost increase for a monolayer for plastic film with the same conditions is $3 (=1×$30×0.1) as explained in the previous paragraph. Therefore, the cost increase is reduced by 10×when the surface layer thickness is reduced proportionally to the original thickness of the plastic film.

For the potential antiviral agent to be used for the plastic films, our extensive research found that copper based agents are the most suitable agent because it is well proven to be effective against coronavirus and also against a broad spectrum of bacteria and fungi. In addition to pure copper, copper-zinc and copper-nickel alloys are also known to be effective against coronavirus as well. Note that the copper metal based agent cause damage to the virus by oxidation or formation of complexes which kill and/or deactivate the virus. More detailed explanations of the killing mechanisms of the coronavirus by copper based metal and alloys (copper-zinc and copper-nickel) have been described in numerous publications in the scientific and medical journals.

In order to determine if copper agent is suitable for the plastic film manufacturing process for making the plastic film with the thin surface layer, one has to consider the following requirements of the antiviral agent: (1) The melting point and their ability to be thoroughly mixed with the plastic pellets in the mixing tank of the plastic film production line, (2) The evaporation temperature and the degradation temperature of the agent with respect to the plastic film processing temperature, and (3) The particle size of the copper agent to be nano-powders due to the ultra-thin antiviral surface layer is targeted to be below 500 nano-meter. Based on our extensive research and test results, we have found the use of the copper metal based agent would not have any issue with the film making process. According to published data, copper has a melting point at about 1080° C.; whereas the melting point for the common polymeric pellets for making plastic film range from 100 to 280° C.

In addition to above information, we have conducted the following four studies to gain a better understanding of the various parameters for our invented Multilayer Plastic Film. Because of the highly transmittable nature of the COVID-19 coronavirus, it is only available for testing by government controlled laboratories. Therefore, we have to use some common bacteria to conduct the following studies in order to gain a better understanding of the basic properties the copper agent in the plastic film. The testing of the effectiveness of the plastic film against common bacteria is in accordance with the procedure for ISO 22196, which specifies that 99.99% of the two bacteria (E. coli and Staph) are killed by the plastic film after 24 hours of challenge. It should be noted that the molecular structures for the common bacteria and the coronavirus are quite different. However, it has been reported in numerous published studies showing that copper is effective in destroying most common bacteria as well as the coronavirus because of the special chemical structure of the copper. A general accepted theory is that copper ion readily react with the bacteria and the coronavirus chemically, most likely by oxidation. For bacteria, the copper ions oxidize and breakdown the cell wall, which kills the bacteria. For coronavirus, the copper ions oxidize the virus molecule which denaturalize its protein molecule and deactivate the virus.

The objective of these studies are as follow: (1) Assuring the copper agent is active in the surface layer, (2) Determining the minimum thickness of the surface layer that can be made, (3) The polymeric materials that can be used for making the antiviral film and (4) The copper based agents that can be used.

Study 1: Assuring the copper agent is chemically active in the thin surface layer. For the plastic film of our interest in the present invention, we have made two mono-layer LDPE film samples of 30 μm in thickness and loaded with 2 levels of concentration of the copper nano-powder. Subsequently, we have made another two plastic film samples with a surface layer of 10 μm and a substrate layer of 20 μm in thickness. The two groups are subjected to the challenge test against E. Coli and Staph per ISO 22196. The test results are summarized in the following table. The test results indicated that the copper agent is chemically active in both the thinner surface layer as well as in the thicker substrate layer.

| | Sample 1 | Sample 2 | Sample 3 | Sample 4 |
|---|---|---|---|---|
| | Mono- | Mono- | Surface | Surface |
| Polymer Material LDPE | Layer | Layer | Layer | Layer |
| Copper Nano-powder | 1% | 10% | | |
| Concentration | | | | |
| in Plastic Film | | | | |
| (by weight) | | | | |
| Copper Nano-powder | | | 1% | 10% |
| Concentration in | | | | |
| Surface Layer | | | | |
| (by weight) | | | | |
| Surface Plastic | none | None | 10 μm | 10 μm |
| Film Thickness | | | | |
| Total Thickness | 30 μm | 30 μm | 30 μm | 30 μm |
| Of Plastic Film | | | | |
| Total Number of Layers | 1 | 1 | 2 | 2 |
| 24 hours ISO 22196 | Pass | Pass | Pass | Pass |
| Antimicrobial | | | | |
| Effective Test | | | | |

Study 2: Determining the minimum thickness of the surface layer that can be made. For the plastic film of our interest in the present invention, we have made 4 samples of plastic film with a surface layer of different thickness and a substrate layer of 100 μm in thickness. The four samples are subjected to the challenge test against E. Coli and Staph per ISO 22196. The test results as summarized in the following table indicated that the thinner surface layer can be made as low as 8 μm. Based on our study, it is not feasible to make a plastic film with the copper agent with thickness below 8 μm using the cast film and blown film making process.

| | Sample 1 | Sample 2 | Sample 3 | Sample 4 |
|---|---|---|---|---|
| Polymer Material | Surface | Surface | Surface | Surface |
| LDPE | Layer | Layer | Layer | Layer |
| Copper Nano-powder | 1% | 1% | 1% | 1% |
| Concentration in | | | | |
| Surface Layer | | | | |
| (by weight) | | | | |
| Surface Plastic | 30 μm | 20 μm | 15 μm | 8 μm |
| Film Thickness | | | | |
| Substrate Thickness | 100 μm | 100 μm | 100 μm | 100 μm |
| for Plastic Film | | | | |
| Total Number of Layers | 2 | 2 | 2 | 2 |
| 24 hours ISO 22196 | Pass | Pass | Pass | Pass |
| Antimicrobial | | | | |
| Effective Test | | | | |

Study 3: Effects of Different Types of Plastic Film Materials. In this study, we have made eight samples using 8 types of polymer film materials: LDPE, HDPC, CPE, CPE, PP, PVC, PET and Nylon. All the samples have a 3-layer structure and all three layers are made of the same material. The total film thickness is 100 μm and surface layer thickness is 15 μm. The concentration for the copper nano-powder is 1% by weight of the surface layer. The test parameters and results are listed in the two tables. In summary, the ISO 22196 test results show that: All the eight types of polymer materials are compatible with the film making process and can be used for making the intended antiviral plastic film.

| | Sample 1 | Sample 2 | Sample 3 | Sample 4 |
|---|---|---|---|---|
| Polymer Material | LDPE | HDPE | EVA | CPE |
| Copper Nano-powder | 1% | 1% | 1% | 1% |
| Concentration in | | | | |
| Surface Plastic Film | | | | |
| (by weight) | | | | |
| Surface Plastic | 15 μm | 15 μm | 15 μm | 15 μm |
| Film Thickness | | | | |
| Total Thickness | 100 μm | 100 μm | 100 μm | 100 μm |
| Of Plastic Film | | | | |
| Total Number of Layers | 3 | 3 | 3 | 3 |
| 24 hours ISO 22196 | Pass | Pass | Pass | Pass |
| Antimicrobial | | | | |
| Effective Test | | | | |

| | Sample 5 | Sample 6 | Sample 7 | Sample 8 |
|---|---|---|---|---|
| Polymer Material | PP | PVC | PET | NYLON |
| Copper Nano-powder | 1% | 1% | 1% | 1% |
| Concentration | | | | |
| in Surface Plastic Film | | | | |
| (by weight) | | | | |
| Surface Plastic | 15 μm | 15 μm | 15 μm | 15 μm |
| Film Thickness | | | | |
| Total Thickness | 100 μm | 100 μm | 100 μm | 100 μm |
| Of Plastic Film | | | | |
| Total Number of Layers | 3 | 3 | 3 | 3 |
| 24 hours ISO 22196 | Pass | Pass | Pass | Pass |
| Antimicrobial | | | | |
| Effective Test | | | | |

Study 4: Effects of Different Types of Copper Based Nano-powders. Below are three experimental samples to determine the effects of three types of copper based nano-powders: copper, copper-zinc alloy and copper-nickel alloy. In this study, we have conducted 3 experiments using the 3 types of copper based nano-powders. All the samples are 3-layer PE film. The substrate layer for the plastic film is 30 μm and surface layer thickness is 10 μm. The concentration for the copper nano-powder is 1% by weight of the surface layer. The test parameters and results are listed in the two tables. In summary, the ISO 22196 test results show that: All the 3 types of copper base materials are effective against the common bacterial and can be used for making the intended antiviral and antimicrobial multilayer film.

| | Sample 1 | Sample 2 | Sample 3 |
|---|---|---|---|
| Copper Based Nano-powders | Copper | Copper-Zinc | Copper-Nickel |
| Polymer Film | PE | PE | PE |
| Copper Nano-powder | 1% | 1% | 1% |
| Concentration | | | |
| in Surface Plastic Film | | | |
| (by weight) | | | |
| Surface Plastic | 10 μm | 10 μm | 10 μm |
| Film Thickness | | | |
| Substrate Thickness | 30 μm | 30 μm | 30 μm |
| Of Plastic Film | | | |
| Total Number of Layers | 3 | 3 | 3 |
| 24 hours ISO 22196 | Pass | Pass | Pass |
| Antimicrobial | | | |
| Effective Test | | | |

The major conclusions for the above studies and other extensive research are that the goal of our invention can be achieved by using a cost effective antivirus plastic film comprising at least one thinner antiviral surface layer and one thicker substrate layer; wherein the surface layer is controllable to be as thin as 8 μm to minimize the amount of the expensive antiviral agent required to render the film to be antiviral: wherein the antiviral agent is characterized to be nano-powders of plain copper, copper-zinc alloy or copper-nickel alloy; wherein the substrate layer can be made of many kinds of polymeric materials with thickness ranging from 20 to 500 μm to provide different physical properties for the plastic film.

The plastic film is made using a co-extrusion cast film or a blown film process so that the antiviral surface layer and the substrate are joined together as they are made into a multilayer film. The film materials used for making any of the layers have to be compatible with the two film making process. From our research, we found the following materials are suitable: Low Density Polyethylene (LDPE), High Density Polyethylene (HDPE), Chlorinated Polyethylene (CPE), Ethylene Vinyl Acetate (EVA), Polypropylene (PP), Polyvinylchloride (PVC), Polyethylene terephthalate (PET) and Nylon. Due to their different molecular structures, the selection of any of these polymers will affect the physical properties of the end products that are made of the multilayer film.

By limiting the expensive copper based nano-powder to the thinner surface layer, the cost for our invented multilayer film is much lower than that for a monolayer antiviral film which requires the copper based nano-powder to be contained in throughout the whole film. Therefore, our invented antiviral film is much more affordable than the conventional single-layer film which requires higher amount of copper based nano-powder to be included throughout the whole film. Further, the thickness and physical properties for the substrate layer of our invented film can be varied by making it with different kinds of polymeric materials. The combination of low cost and variable physical properties enables our invented plastic film to be used for making a wide variety of affordable and safer protection products which are much more effective to protect against the coronavirus than the regular protection products. Such products include but not limited to the following protection and medical products: (a) Bags and wrappers for storage and waste, (b) Covers for hospital beds, trolleys, chairs, counters, furniture and elevator buttons, (c) Curtains and tents for patient isolation and hospital entrances, (f) Surgery accessories such as gowns, drapes, head caps and shoe covers, (g) Covers for tables and seats in restaurants, buses and airplanes. (a) Gloves for medical use and food handling, (b) Masks and respirators for personal protection.

1. A cost effective antivirus plastic film comprising at least one thinner antiviral surface layer and at least one thicker substrate layer; wherein the surface layer is controllable to be as thin as 8 μm to minimize the amount of the high-cost copper based agent required to render the film to be antiviral; wherein the substrate layer can be made of various kinds of polymeric materials with thickness variable from 20 to 500 μm to provide different physical properties for the plastic film.

2. A cost effective antivirus plastic film according to claim 1, wherein the making of the plastic film is characterized by a 3-step process comprising of: (i) The formation of the surface layer involving a thorough mixing of the copper agent of a predetermined concentration ratio with the plastic pallets at temperatures above the melting point of the plastic pallets before feeding into the co-extrusion head; (ii) The formation of the substrate layer involving the feeding of the melted, regular plastic pallets into the co-extrusion head; (iii) The formation of the antiviral plastic film involving the co-extrusion of the surface layer with the substrate layer and the subsequent blown film or cast film making process.

3. A cost effective antivirus plastic film according to claim 1, wherein the plastic film is made by a co-extrusion cast film process; wherein the surface layer thickness is controllable to be as low as 8 μm; wherein the substrate thickness of the plastic film ranges from 20 to 500 μm.

4. A cost effective antivirus plastic film according to claim 1, wherein the plastic film is made by a co-extrusion blown film process; wherein the surface layer thickness is controllable to be as low as 8 μm; wherein the substrate thickness of the plastic film ranges from 20 to 500 μm.

5. A cost effective antivirus plastic film according to claim 1, wherein the surface and substrate layer can be made using any of the following materials: Low Density Polyethylene (LDPE), High Density Polyethylene (HDPE), Chlorinated Polyethylene (CPE), Ethylene Vinyl Acetate (EVA), Polypropylene (PP), Polyvinylchloride (PVC), Polyethylene terephthalate (PET) and Nylon.

6. A cost effective antivirus plastic film according to claim 1, wherein the surface layer is made of LDPE and the substrate layer is made of any of the following materials: Low Density Polyethylene (LDPE), High Density Polyethylene (HDPE), Chlorinated Polyethylene (CPE), Ethylene Vinyl Acetate (EVA), Polypropylene (PP), Polyvinylchloride (PVC), Polyethylene terephthalate (PET) and Nylon.

7. A cost effective antivirus plastic film according to claim 1, wherein the antiviral copper base agent is characterized by being a powder of plain copper, copper-zinc alloy or copper-nickel alloy; wherein the powder size is below 500 nano-meter.

8. A cost effective antivirus plastic film according to claim 1, wherein the invented film can be used for making the following antiviral protection products:
(a) Bags and wrappers for storage and waste, (b) Covers for hospital beds, trolleys, chairs, counters, furniture and elevator buttons, (c) Curtains and tents for patient isolation and hospital entrances, (f) Surgery accessories such as gowns, drapes, head caps and shoe covers, (g) Covers for tables and seats in restaurants, buses and airplanes, (a) Gloves for medical use and food handling, (b) Masks and respirators for personal protection.
